(19) United States
(12) Patent Application Publication
(10) Pub. No.: US 2015/0221461 A1
(43) Pub. Date: Aug. 6, 2015

(54) Rotary Operation Switch and Strobe Device Including Same

(71) Applicant: Nissin Industries LTD, North Point (CN)

(72) Inventor: Chun Nin MAN, North Point (CN)

(21) Appl. No.: 14/606,120

(22) Filed: Jan. 27, 2015

(30) Foreign Application Priority Data
Jan. 31, 2014 (JP) 2014-016437

(51) Int. Cl. H01H 19/20; G03B 15/05

(52) U.S. Cl. CPC H01H 19/20; G03B 15/05

(57) ABSTRACT

A rotary operation switch including a support body, an operation member rotatably supported by the support body and a switch mechanism provided therebetween to define multiple positions in a rotational direction of the operation member, wherein one of the support body and the operation member defines multiple recesses corresponding to the multiple positions, and wherein the rotary operation switch includes: a movable engaging body formed of a permanent magnet or a magnetic material and provided on the other of the support body and the operation member to engage with or disengage from the recesses as the operation member is rotated; a guiding portion provided on the other of the support body and the operation member to guide the engaging body; and a magnetic attractive force generation portion provided on the one of the support body and the operation member to exert magnetic attractive force on the engaging body.

### TECHNICAL FIELD

The present invention relates to a rotary operation switch and a strobe device including the same, and in particular to a rotary operation switch which provides a click feeling at contact positions when a rotating operation is carried out, and a strobe device including the same.

### BACKGROUND OF THE INVENTION

Conventionally, cameras, strobe devices or the like may be provided with a rotary operation switch having a dial-type rotary operation member which has a terminal attached thereto and which is rotatable to set various conditions. Some of such rotary operation switches are configured to provide a click feeling to allow a user to know that the rotary operation switch has reached a setting position when the rotary operation switch is operated manually (refer to JP 2011-146358A, for instance).

The operation switch of JP 2011-146358A includes a cylindrical plunger coaxial with the rotary operation member which is to be manually operated. The cylindrical plunger is provided with a side hole extending in a horizontal direction or perpendicularly to an axial direction. The side hole is provided therein with a coil spring which urges outwardly from the inside of the plunger a pair of balls provided at either end of the coil spring. The rotary operation member is provided with a plunger insertion hole extending in the axial direction and the inner circumference of the plunger insertion hole is formed as a corrugated surface, so that when the rotary operation member is rotated for an operation, the balls urged by the coil spring move along the side hole forwardly and backwardly following the corrugated surface, whereby the rotational resistance of the rotary operation member is varied and a click feeling is obtained.

### SUMMARY OF THE INVENTION

However, in the operation switch of JP 2011-146358A, since the balls are urged by the coil spring and pushed onto the corrugated surface for obtaining a click feeling, it is necessary during assembly to insert the plunger into the plunger insertion hole of the rotary operation member while the balls are pressed into the side hole against the urging force of the coil spring. It is preferable that the coil spring exert a large urging force for obtaining a strong click feeling. However, in that case, the force urging the balk becomes large and, since it becomes necessary to assemble the plunger into the plunger insertion hole of the rotary operation member while pressing the balls inside the side hole of the plunger against the large urging force, assembling workability is lowered. In addition, when the plunger is removed for a repair, if the balls are not properly held, the balls may be scattered by the urging force of the coil spring.

To solve such problems and to realize a rotary operation switch which provides a strong click feeling and which can improve assembling and disassembling workability and a strobe device including such a rotary operation switch, the present invention provides a rotary operation switch including a support body (12), a rotary operation member (31) rotatably supported by the support body and a switch mechanism (55, 56, 57) provided between the rotary operation member and the support body to define a plurality of positions in a rotational direction of the rotary operation member, wherein one of the support body and the rotary operation member defines a plurality of recesses (42) corresponding to the plurality of positions in the rotational direction of the rotary operation member, and wherein the rotary operation switch includes: a movable engaging body (42) formed of a permanent magnet or a magnetic material and provided on the other of the support body and the rotary operation member such that the movable engaging body is moveable in a direction intersecting the rotational direction to engage with or disengage from the recesses as the rotary operation member is rotated; a guiding portion (61) provided on the other of the support body and the rotary operation member such that the guiding portion guides the movable engaging body in the direction intersecting the rotational direction; and a magnetic attractive force generation portion (32) provided on the one of the support body and the rotary operation member such that the magnetic attractive force generation portion exerts magnetic attractive force on the movable engaging body.

According to this structure, in the rotary operation switch provided with a switch mechanism for detecting a plurality of positions, when the rotary operation member is rotated, the movable engaging body engages with the recesses one by one to provide a click feeling. In addition, since the engagement between the movable engaging body and the recesses is achieved by magnetic attractive force, it is possible to handle the movable engaging body integrally with the rotary operation member by having the movable engaging body attached to the recess with magnetic attractive force. Thus, unlike the conventional structure where a coil spring is employed to provide urging force, there is no need to hold the movable engaging body against the urging force of the coil spring when handling the movable engaging body, and thus, the assembling workability is improved.

Preferably, the moving engaging body consists of a spherical body, and each recess to be engaged with the movable engaging body defines a circular opening having a diameter smaller than that of the spherical body.

If an urging force were provided to the movable engaging body by a coil spring as in the conventional structure, the spherical movable engaging body may contact the edge of the circular opening of each recess only partially due to a deflection of the spring coil. However, according to this structure, the movable engaging body and the recess abut each other along the entire edge of the circular opening owing to the magnetic attractive force, and thus, it is possible to always achieve a stable engaged state. When the movable engaging body disengages from one recess and engages the next recess as the rotary operation member is rotated, the spherical movable engaging body can freely roll, and thus, the rotary operation member can be rotated smoothly without being subject to high resistance.

It is also preferable that the guiding portion is configured to guide the movable engaging body in a direction parallel to an axis of rotation of the rotary operation member, and that each recess opens in a direction perpendicular to the rotational direction of the rotary operation member.

According to this structure, the movable engaging body moves with respect to each recess in the direction intersecting the rotational direction of the rotary operation member, and a resistance against the operation of the rotary operation member in the rotational direction is obtained when the movable engaging body and the recess engage each other. When the rotary operation member is rotated against the resistance and the movable engaging body comes into point contact with a plate-like portion (i.e., a portion free of the recesses) of the one of the support body and the rotary operation member, the resistance is lowered and the rotational operation can be carried out easily.

It is also preferable that the guiding portion is provided on the support body and is composed of a through hole having the movable engaging body inserted therein.

According to this structure, it is possible to insert the movable engaging body into the guiding portion from the side opposite to the rotary operation member even after the rotary operation member is assembled with the support body, whereby there is no restriction in assembly and workability can be improved.

Thus, according to the present invention, in the rotary operation switch provided with a switch mechanism for detecting a plurality of positions, when the rotary operation member is rotated, the movable engaging body engages with the recesses one by one and provides a click feeling. In addition, since the engagement between the movable engaging body and the recesses is achieved by magnetic attractive force, it is possible to handle the movable engaging body integrally with the rotary operation member by having the movable engaging body attached to the recess with magnetic attractive force. Thus, unlike the conventional structure where a coil spring is employed to provide urging force, there is no need to hold the movable engaging body against the urging force of the coil spring when handling the movable engaging body, and thus, the assembling workability is improved.

### BRIEF DESCRIPTION OF THE DRAWINGS

Now the present invention is described in the following in terms of preferred embodiments thereof with reference to the appended drawings, in which:

FIG. 1 is a perspective view of a strobe device according to an embodiment of the present invention as seen from a front side;

FIG. 2 is a perspective view of the strobe device according to the present embodiment as seen from a rear side;

FIG. 3 is an exploded perspective view of main parts of a number setting dial to which the present invention is applied;

FIG. 4 is a perspective view showing a back side of a rotary operation member of the number setting dial, with a plate body being attached to the rotary operation member; and

FIG. 5 is a cross sectional view showing an. assembled state of the number setting dial taken along line V-V in FIG. 4.

### DETAILED DESCRIPTION OF THE PREFERRED EMBODIMENTS

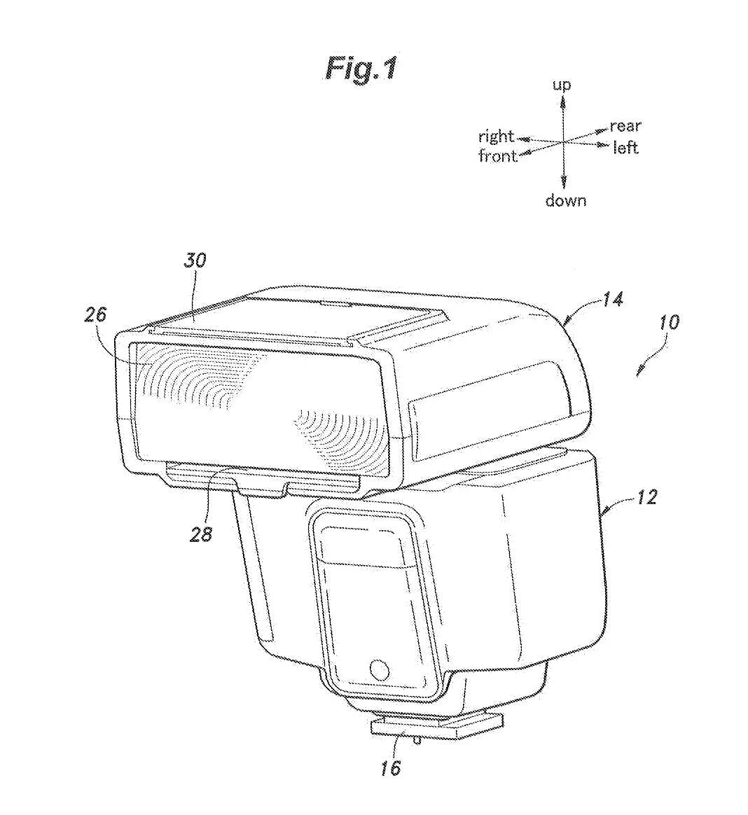

In the following, an embodiment of a strobe device according to the present invention will be described with reference to FIGS. 1-5.

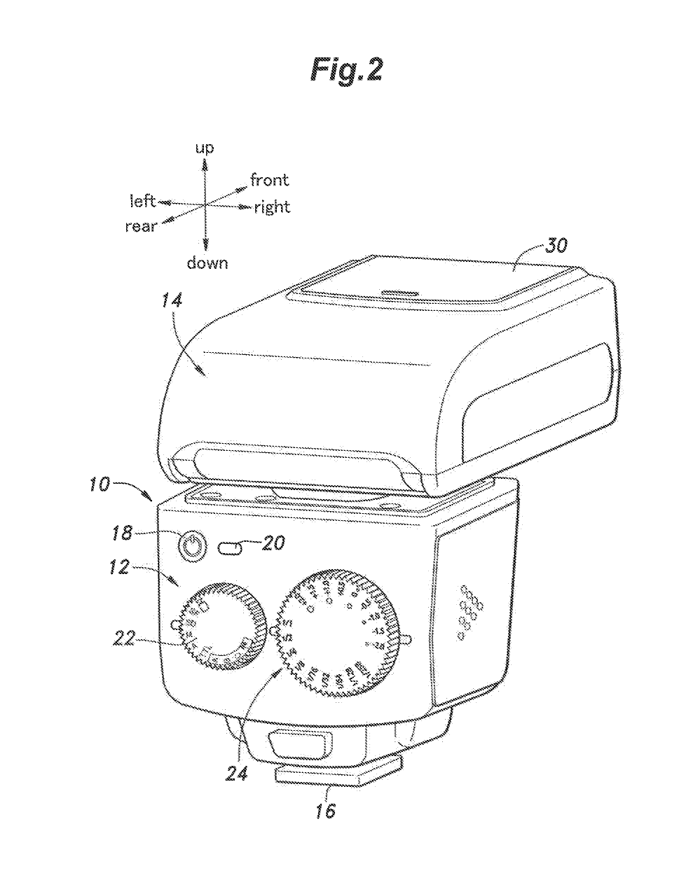

As shown in FIGS. 1 and 2, the strobe device 10 includes a lower strobe main body 12 as a support body and an upper strobe main body 14 which is attached to an upper portion of the lower strobe main body 12 so as to be pivotable around a vertical axis and a horizontal axis.

The lower strobe main body 12 has a mounting portion 16 at its lower bottom to be mounted to a camera (not shown) and contains a battery case, electrical components, a control circuit, etc. therein. A rear portion 13 of the lower strobe main body 12 is provided with a power switch button 18, a power indicator 20, a mode selection dial 22 and a number setting dial 24.

The upper strobe main body 14 includes an internal flash light source such as a xenon discharge tube and has a light emitting surface 26 composed of a Fresnel lens at a front portion thereof. The upper strobe main body 14 includes a wide angle diffuser panel 28 which is storable at a lower side of the light emitting surface 26 and a plate-like reflector (a reflector board) 30 which is storable at an upper side of the light emitting surface 26.

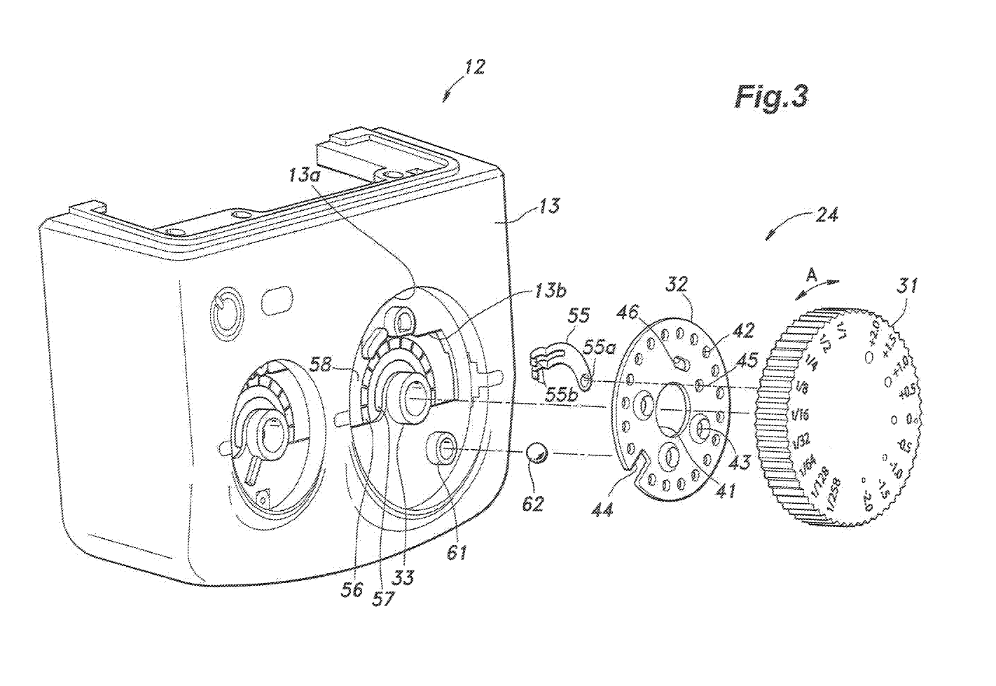

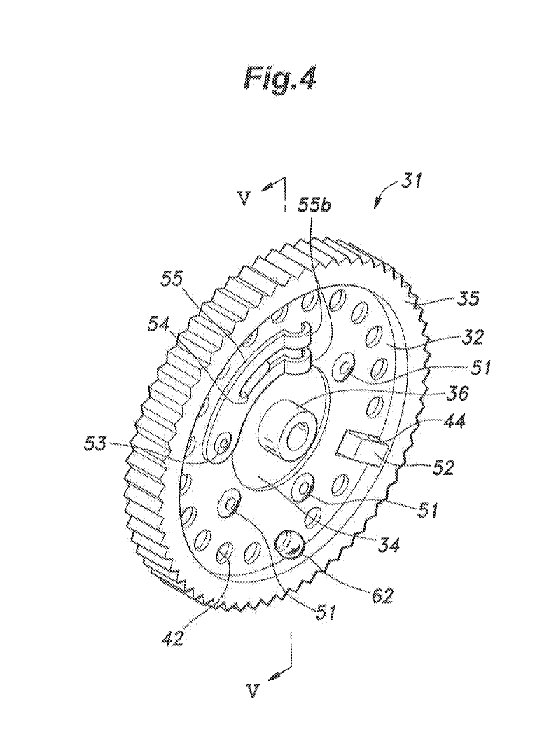

FIG. 3 is an exploded perspective view of main parts of the number setting dial 24 employing the present invention. The number setting dial 24 includes a disc-like rotary operation member 31 which is to be rotated for manual operation and a plate body 32 which is fixed on the back side (facing the rear portion 13 of the lower strobe main body 12) of the rotary operation member 31 as is also shown in FIG. 4. In the illustrated example, the rotary operation member 31 is formed by molding synthetic resin material and the plate body 32 is formed as a magnetic attractive force generation portion by press forming a thin plate-like magnetic body.

The rear portion 13 of the lower strobe main body 12 is provided with a circular recess 13a for receiving substantially the half of the rotary operation member 31 in its axial direction. A cylindrical boss 33 protrudes from the center of a bottom surface of the recess 13a. As shown in FIG. 4, the back side of the rotary operation member 31 is composed of a generally flat bottom surface 34 and an annular circumferential wall portion 35 which is provided at an outer circumference of the bottom surface 34. A cylindrical shaft portion 36 protrudes from the center of the bottom surface 34 and the shaft portion 36 is received and rotatably supported by the boss 33.

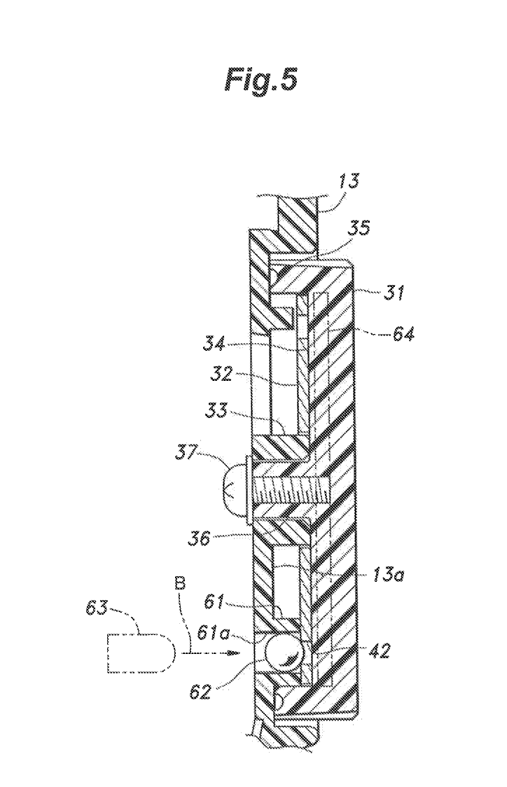

It is to be noted that, as shown in FIG. 5, by screwing a screw 37 into an axial hole of the shaft portion 36 when the shaft portion 36 is supported by the boss 33, the rotary operation member 31 is attached to the rear portion 13 of the lower strobe main body 12.

The plate body 32 is provided at its center with a hole 41 having a size for receiving the boss 33 therein, a plurality of index holes 42 composed of through-holes which are arranged circumferentially, for example, at regular intervals in an outer peripheral part of the plate body 32, and fixing holes 43 placed between the hole 41 and index holes 42 (three fixing holes 43 in the illustrated example). The index holes 42 serve as recesses of the present invention. The plate body 32 is also provided with a radial notch 44 which has a shape of a slit extending from the outer circumference of the plate body 32 in the radially inward direction, a terminal mounting opening 45 and a terminal positioning opening 46.

The bottom surface 34 of the rotary operation member 31 is provided with three protrusions 51 at positions corresponding to those of the three fixing holes 43, a ridge 52 extending in the radial direction at a position corresponding to that of the radial notch 44, a protrusion 53 at a position corresponding to that of the terminal mounting opening 45 and a ridge 54 extending in the circumferential direction at a position corresponding to that of the terminal positioning opening 46. The hole 41 of the plate body 32 is fitted over the boss 33 and the radial notch 44 of the plate body 32 is engaged with the ridge 52 so that the plate body 32 is circumferentially positioned with respect to the rotary operation member 31, and in this state, an exposed end of each protrusion 51 passing through the corresponding fixing hole 43 is expanded by a tool (not shown), whereby the plate body 32 is fixed to the bottom surface 34 of the rotary operation member 31.

As shown in FIGS. 3 and 4, a terminal 55 is formed to have an arc-shape extending along the rotational direction of the rotary operation member 31 (arrow A in FIG. 3). The terminal 55 is provided with a fixing hole 55a at one end in the direction of extension of the terminal 55 and the other end of the terminal 55 is formed to have a bifurcated fork shape whose extended ends constitute a pair of contact portions 55b. The terminal 55 formed in this manner is fixed to the bottom surface 34 of the rotary operation member 31 by aligning the fixing hole 55a with the terminal mounting opening 45 of the plate body 32 and expanding an end of the protrusion 53 of the rotary operation member 31 by a tool (not shown) after passing the protrusion 53 through the terminal mounting opening 45 and the fixing hole 55a. It is to be noted that the ridge 54 of the rotary operation member 31 is placed between the pair of contact portions 55b formed in the bifurcated fork shape of the terminal 55, whereby the terminal 55 is positioned with respect to the rotary operation member 31.

The bottom surface of the recess 13a is provided with an opening 13b which circumferentially extends substantially halfway around the boss 33. The opening 13b exposes arc-shaped conductive patterns 56 and 57 with greater and smaller radii, respectively, formed on a circuit board 58 provided on the back side of the recess 13a (inner side of the lower strobe main body 12). These conductive patterns 56 and 57 and the terminal 55 constitute a switch mechanism. Each of the conductive patterns 56 and 57 extends in an arc shape coaxial with the boss 33. The pair of contact portions 55b slidably contacts the conductive patterns 56 and 57 when the rotary operation member 31 is rotated. In the illustrated example, the conductive pattern 56 having a greater radius is divided into multiple parts corresponding to the spacing between the plurality of index holes 42.

The bottom surface of the recess 13a is provided with a cylindrical guiding portion 61 such that it protrudes toward the plate body 32 at a position where the index holes 42 passes as the rotary operation member 31 is rotated. In the illustrated example, a ball 62 of permanent magnet is received in the cylinder of the cylindrical guiding portion 61 as a movable engaging body. It is to be noted that the inner diameter of the cylindrical guiding portion 61 is set such that the ball 62 can move in the axial direction of the cylindrical guiding portion 61, namely in the direction in which the ball 62 comes into contact with or disengages from the plate body 32, smoothly and without rattling. In addition, the index holes 42 are formed in the plate body 32 as through holes each having an inner diameter smaller than the diameter of the ball 62. It is to be noted that, as shown in FIG. 5, the protruding end of the cylindrical guiding portion 61 is configured to come close to the plate body 32 when the rotary operation member 31 is attached to the boss 33.

The plurality of index holes 42 are provided such that they correspond to a plurality of values to be set by the number setting dial 24. For example, for manual settings, nine settings are possible in the range from the maximum. light intensity (1/1) to the minimum light intensity (1/256), and for automatic settings, nine settings are possible in the range from +2.0 to −2.0. It is to be noted that switching between the manual setting and automatic setting is carried out by the mode selection dial 22.

In the number setting dial 24 configured in this manner, the cylindrical guiding portion 61 is brought into alignment with the index holes 42 one after another when the rotary operation member 31 is rotated. The ball 62 which is received in the cylindrical guiding portion 61 in freely movable manner in the axial direction of the cylindrical guiding portion 61 is always in contact with the plate body 32 due to the magnetic attractive force between the hall 62 and the plate body 32. If the cylindrical guiding portion 61 is aligned with one of the index holes 42 as a result of rotating of the rotary operation member 31, the ball 62 moves into the index hole 42. Since the diameter of the ball 62 is greater than the inner diameter of the index hole 42, only a portion of the ball 62 moves into the index hole 42 and the remaining large portion of the ball 62 is held in the cylindrical guiding portion 61. When the ball 62 moves into the index hole 42, the spherical surface of the ball 62 abuts the entire circumferential edge of the index hole 42 and the ball 62 is kept in a state where the ball 62 moves into the index hole 42, and thus, a large resistance against the rotation of the rotary operation member 31 is created and the rotary operation member 31 is stably kept in one of the setting positions.

If a coil spring were used to urge the ball as in a conventional structure a problem may arise that it is difficult to make the structure compact for such reasons as that a hole for retaining the coil spring therein requires an additional length which tends to increase the thickness of the structure. In contrast, in the illustrated embodiment of the present invention, the urging force is provided as a magnetic force and there is no coil spring used, and hence, the structure can be made compact. Further, in the illustrated embodiment, the strength of click feeling can be adjusted by varying the strength of magnetic attractive force, and thus, the strength of click feeling can be easily changed without changing the external shape of each component part. Thereby, when the rotary operation member 31 is rotated, a sufficient click feeling is achieved each time the ball 62 moves into the index hole 42 and engages therein, and thus, the operation to change settings using the number setting dial 24 can be surely carried out.

In addition, during assembling work, by placing the ball 62 in the index hall 42, the ball 62 can be held in and fixed at the index hall 42 due to magnetic attractive force, and therefore, the rotary operation member 31 and the ball 62 can be handled as a unit. Thus, when inserting the shaft portion 36 of the rotary operation member 31 into the boss 33, it is not necessary to hold the ball 62, and thus, workability can be improved.

As shown in FIG. 5, the cylindrical guiding portion 61 is formed of a through hole 61a extending through the wall of the rear portion 13, whereby, even after the rotary operation member 31 is assembled with the lower strobe main body 12, it is possible to mount the ball 62 by inserting the ball 62 through the through hole 61a from the back side of the rear portion 13 (the side opposite to the side close to the rotary operation member 31) as shown by an arrow B in FIG. 5. The ball 62 is attracted and held by the plate body 32 due to magnetic attractive force from the plate body 32 when the ball 62 has been inserted into the through hall 61a to some extent. Thus, assembly work of the ball 62 can be easily carried out.

Further, the position of each index hole 42 is adjusted such that the distance between the ball 62 received in the index hole 42 and the shaft portion 36 is set to be a little smaller than the distance between the inner wall surfaces of the through holes of the boss 33 and cylindrical guiding portion 61, so that the ball 62 and the shaft portion 36 press the boss 33 and the cylindrical guiding portion 61 in the radial direction when the shaft portion 36 is inserted into the boss 33 and the ball 62 is inserted into the cylindrical guiding portion 61, whereby the boss 33 and the cylindrical guiding portion 61 are held between the shaft portion 36 and the ball 62, and thus, the rotary operation member 31 is temporarily fastened to the lower strobe main body 12 even before tightening the screw 37. This makes the tightening operation of the screw 37 easy.

Although the present invention has been described in terms of a preferred embodiment thereof in the forgoing, it is obvious to a person skilled in the art that the present invention is not limited to such an embodiment, and various modifications are possible without departing from the spirit of the present invention. For example, in the foregoing embodiment, the ball 62 is adapted to receive the magnetic attractive force from the index hole 42 aligned therewith in the direction parallel to the direction of the axis (rotational axis) of the rotary operation member 31. However, it is also possible to provide the rotary operation member 31 with an annular plate body which encircles the outer circumferential surface of the boss 33 and which has index holes each opening in the radial direction and to guide the ball 62 so as to be movable in the radial direction. It is to be noted that not all the structural components in the embodiment described above are necessarily indispensable, but they may be selectively adopted without departing from the spirit of the present invention.

For example, although, in the above illustrated example, the movable engaging body is embodied as the ball 62 having the shape of a perfect sphere, the movable engaging body may also be embodied as a movable engaging body 63 having the shape of an artillery shell as shown by a two-dot chain line in FIG. 5, for example. The movable engaging body 63 is held in a freely movable manner in the axial direction at its cylindrical portion by the cylindrical guiding portion 61 and can achieve an engaged state similar to that of the ball 62 by constructing the protruding end as a semi sphere.

In addition, although the ball 62 is formed of a permanent magnet and the plate body 32 is formed of magnetic material, conversely, the ball 62 may be formed of magnetic material and the plate body 32 may be formed of a permanent magnet. Furthermore, the plate body 32 may be formed of rigid plastic, for example, and a disk 64 made of a permanent magnet may be embedded in the rotary operation member 31 such that the ball 62 receives the magnetic attractive force from the disk 64. Conversely, the plate body 32 formed of rigid plastic and the disk 64 formed of a permanent magnet may be provided on the rear portion 13 and the ball 62 formed of magnetic material may he supported by the cylindrical guiding portion 61 provided to the rotary operation member 31.

It is to he noted that a strobe device has been described in the foregoing embodiment, but the rotary operation switch according to the present invention is not limited to use in the strobe device. The rotary operation switch is applicable to, for example, setting dials for shutter speed and aperture value of a camera.

1. A rotary operation switch including a support body, a rotary operation member rotatably supported by the support body and a switch mechanism provided between the rotary operation member and the support body to define a plurality of positions in a rotational direction of the rotary operation member,
wherein one of the support body and the rotary operation member defines a plurality of recesses corresponding to the plurality of positions in the rotational direction of the rotary operation member,
and wherein the rotary operation switch comprises:
a movable engaging body formed of a permanent magnet or a magnetic material and provided on the other of the support body and the rotary operation member such that the movable engaging body is moveable in a direction intersecting the rotational direction to engage with or disengage from the recesses as the rotary operation member is rotated;
a guiding portion provided on the other of the support body and the rotary operation member such that the guiding portion guides the movable engaging body in the direction intersecting the rotational direction; and
a magnetic attractive force generation portion provided on the one of the support body and the rotary operation member such that the magnetic attractive force generation portion exerts magnetic attractive force on the movable engaging body.

2. The rotary operation switch according to claim 1,
wherein the movable engaging body consists of a spherical body; and
wherein each recess to be engaged with the movable engaging body defines a circular opening having a diameter smaller than that of the spherical body.

3. The rotary operation switch according to claim 1,
wherein the guiding portion is configured to guide the movable engaging body in a direction parallel to an axis of rotation of the rotary operation member; and
wherein each recess opens in a direction perpendicular to the rotational direction of the rotary operation member.

4. The rotary operation switch according to claim 1, Wherein the guiding portion is provided on the support body and is composed of a through hole having the movable engaging body inserted therein.

5. A strobe device comprising the rotary operation switch according to claim 1.
